(19) United States
(12) Patent Application Publication
(10) Pub. No.: US 2008/0187464 A1
(43) Pub. Date: Aug. 7, 2008

(54) Microscope Slide Load/Unload Mechanism

(75) Inventors: Wei Guo, Unionville, CT (US); Yash Agarwal, New Haven, CT (US); Youngmin Kim, Wallingford, CT (US); Triantafyllos Tafas, Rocky Hill, CT (US)

Correspondence Address: KELLEY DRYE & WARREN LLP, 400 ALTLANTIC STREET , 13TH FLOOR, STAMFORD, CT, 06901, US

(73) Assignee: Ikonisys, Inc., New Haven, CT (US)

(21) Appl. No.: 11/833,428

(22) Filed: Aug. 3, 2007

Related U.S. Application Data
(60) Provisional application No. 60/821,549, filed on Aug. 4, 2006.

(51) Int. Cl. B01L 11/00

(52) U.S. Cl. 422/99

(57) ABSTRACT

An apparatus for the feeding of microscope slides from a storage device to a slide stage.

This application claims priority from U.S. Provisional Patent Application Ser. No. 60/821,549, filed Aug. 4, 2006. All references cited in this specification, and their references, are incorporated by reference herein where appropriate for teachings of additional or alternative details, features, and/or technical background.

### BACKGROUND OF THE INVENTION

1. Field of the Invention

The present invention generally relates to automated microscopes.

2. Description of the Related Art

Conventional optical microscopy generally employs a microscope slide to which a biological sample has been affixed, and at least one objective lens that is used to focus on discrete areas of the biological sample in a search for structures of interest, such as cells, nuclei, etc. Microscopes historically have consisted of an optical portion including the eyepiece, body tube and objective; the frame, made up of a limb, joint and foot; and the stage, a flat surface to which the microscope slide is positioned for viewing.

The microscope slide, usually a thin rectangular piece of glass roughly one inch by three inches, has heretofore has been loaded onto the microscope stage by hand. Taking a slide from a stack or storage tray, an operator would place the slide on the stage. Using his fingers he would position it by free hand or against some stop, taking care not to handle the examination area, or disrupt the cover slide if used. Once the slide is examined, the operator would remove the slide and either replace it back into the tray or return it to a stack.

Automated microscopy has gained favor for rapid examination of a sample contained on a slide, however, the operator is still required to handle the slides. Furthermore, diagnostic requirements and new testing procedures necessitate higher accuracy and shorter processing times. Samples once prepared by hand are becoming more automated, increasing the slide counts into the hundreds, and requiring cleaner processes to minimize contamination and error, especially as the magnification levels rise.

With each of these increasingly stringent constraints operators face insurmountable requirements to test hundreds of slides accurately for conditions sensitive to handling while patients must wait until all the samples are checked and cross checked. As the trend only appears to be increasing, both in complexity and magnitude of samples examined, there exists a need for more accurate, rapid and clean handling of microscope slides.

### SUMMARY OF THE INVENTION

Embodiments disclosed herein include:

A microscope slide manipulation device, the device comprising: a base structure; a sleeve defining a through-void, the sleeve having a first end and a second end, the second end fastened to the base, and the sleeve being oriented perpendicular to the base; a longitudinal shaft symmetric about an imaginary longitudinal axis in part positioned in the sleeve through-void in a manner to permit axial and longitudinal movement of the longitudinal shaft in the sleeve through-void, the longitudinal shaft having a shaft first end and a shaft second end, the shaft second end positioned within the sleeve through-void and the shaft first end projecting beyond the sleeve first end and including a parallel track structure in a plane perpendicular to the sleeve imaginary longitudinal axis; a plate slideably positioned between the parallel track structures on the sleeve first end, the plate having a first plate end and a second plate end, one of the first plate end or second plate end having the form of a fork having at least two prongs, in a same plane, defining a void area between each prong that corresponds to the width of a microscope slide, and wherein the fork has a gripping structure operatively configured to permit gripping of a microscope slide along its edges. The microscope slide manipulation device further comprising the fork having an additional flat prong in another plane, parallel to the same plane. In an embodiment, a microscope slide manipulation device further comprising: a first linear actuator which linearly translates the longitudinal shaft operatively connected between the sleeve and the longitudinal shaft; a rotational actuator which rotationally translates the parallel track structure in plane perpendicular to the longitudinal shaft operatively connected between the longitudinal shaft and an element chosen from the group consisting of the base structure and the parallel track structure; a second linear actuator which linearly translates the plate operatively connected between the plate and the parallel track structure. In addition, the embodiment may include at least one position determining sensor operationally configured to telemeter position of the two pronged fork with respect to the structural base.

### DETAILED DESCRIPTION OF THE INVENTION

In an embodiment, the microscope slide load/unload mechanism, is a robotic arm having one or more actuated joints, providing the capability of removing a slide from a storage medium, positioning the slide in the microscopes optical path in any desired orientation, and subsequently returning the slide to a designated storage medium. This feature facilitates both upright and inverted microscopy. The robotic arm provides the capability of positioning the slide independently in three orthogonal displacement axis and three orthogonal orientation axis.

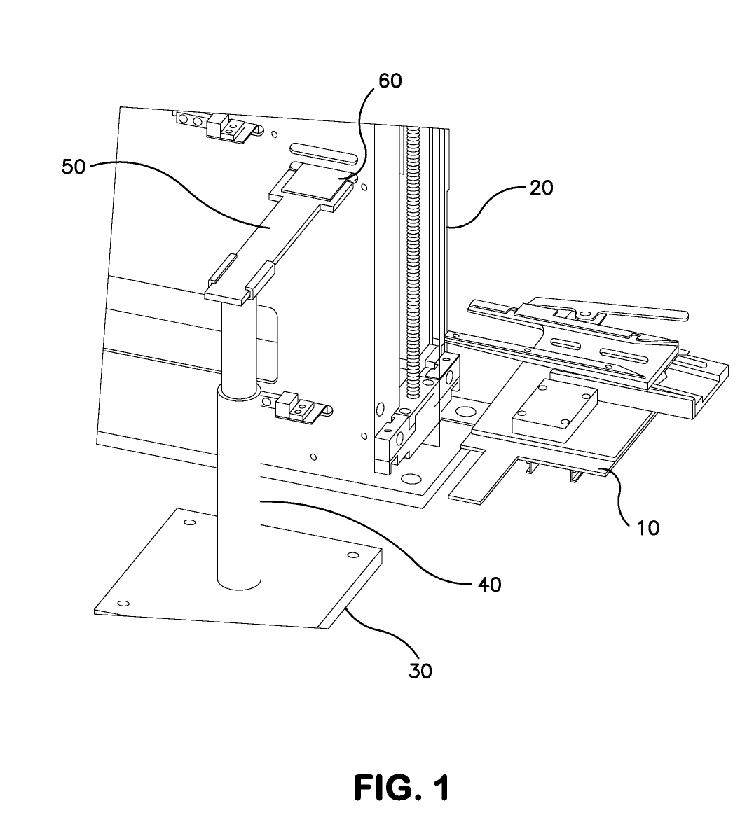

Turning to FIG. 1, there is disclosed a schematic illustration of an embodiment of a microscope slide loading/unloading mechanism.

As indicated in FIG. 1, microscope slide 60 is transferred from slide library 20 into one end of feed arm 50. In this embodiment, feed arm 50, shown rotated ninety degrees relative to slide stage 10, is aligned so as the longitudinal centerline of feed arm 50 coincides with that of microscope slide 60 from slide library 20. Furthermore, feed arm 50 is shown in its extended lateral position relative to support column 40, and toward slide library 20. Operatively connected to feed arm 50 at one end, support column 40 is further connected to base 30 to provide support during operation.

In an alternative embodiment in FIG. 1 the support column 40 extends and retracts in a vertical direction providing for further enhancement to the operation. In another embodiment, support column 40 may rotate about base 30, about its midsection, or about its upper end. The slide loading/unloading mechanism may service more than one slide library 20, and in yet another embodiment feed arm 50 may have two or more ends.

The slide feed arm may be used for loading cassettes with prepared microscope slides, which slides may be prepared manually or automatically, and unloading the slides from a loaded cassette. While illustrated that the slide feed arm unloads a microscope slide to a stage, it should be understood that the slide feed arm may unload the microscope slide to any surface or to any device that performs a front end application on the prepared slide. Loading and unloading of slides may be performed using the same slide feed arm or may entail the use of two or more slide feed arms.

Loading/unloading of slides from the cassettes may entail movement of the cassette in a manner to allow the next slide in the cassette to be brought up to a position in which the loading arm may grab the same. Thus the cassette may be positioned on a platform that moves in a direction, as displaced by a motor driven lead screw actuator. The cassette itself may be moved in a direction (for example in a vertical movement allowing for the next shelf to reach the vertical position of the previous unloaded shelf), or the cassette may include a racking mechanism in which each of the shelves may be moved upwardly after the prior shelf is unloaded or loaded.

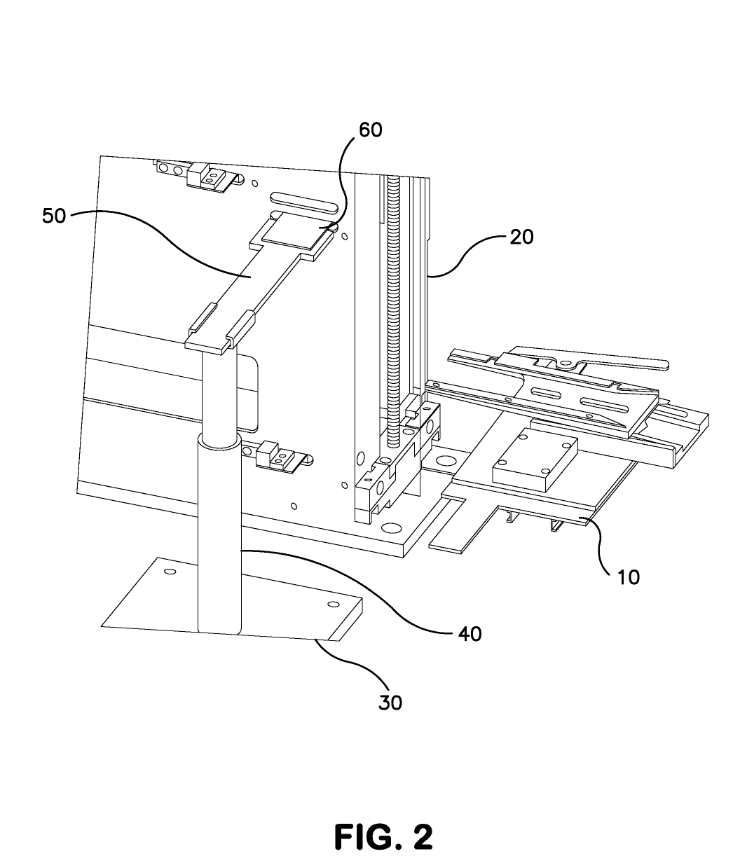

FIG. 2, a continuation of FIG. 1, shows microscope slide 60 fully engaged in feed arm 50.

Slide engagement in the feeding arm may entail a whole host of mechanisms, including frictional holding of the slide along its sides between each of the prongs of a dual-pronged fork, air suction onto the fork surface, etc. The fork may include resilient structure at the prong surfaces used to grab the slide, providing for tension against the sides of the slides when held between the fork prongs. The resilient structure includes, without limitation, elastic material, movable housings including springs, and flexible pieces of materials that are configured with respect to the prong to form bendable tabs. The fork may include a prong which is in another plane than other prongs. For example, the fork may comprise a two-pronged fork in one plane, having a flat prong in another plane attached to the fork. Thus the fiat prong may provide additional support in moving the slide when held between the two prongs in the first plane.

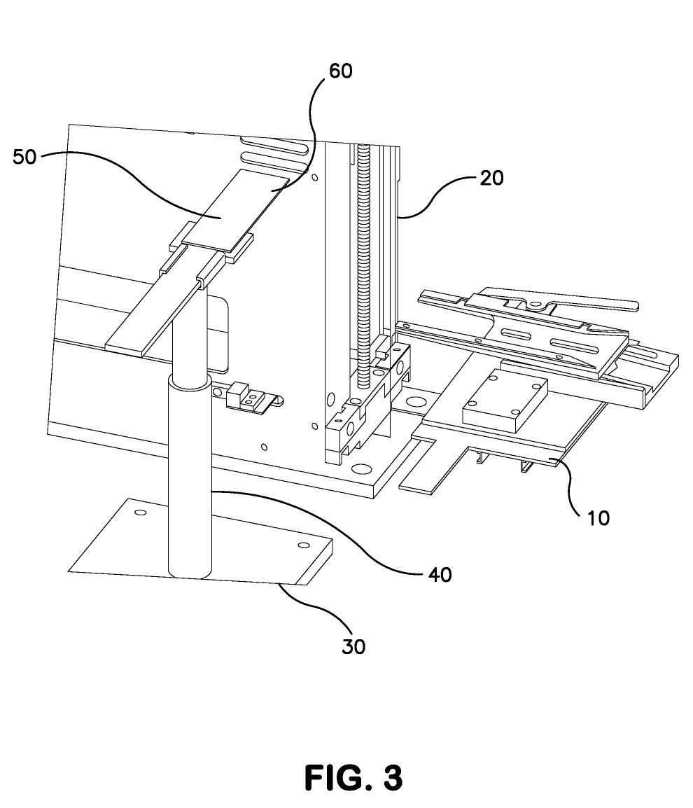

FIG. 3, a further continuation of FIG. 2, depicts microscope slide 60 fully seated in feed arm 50 with feed arm 50 retracted such that microscope slide 60 is clear of slide library 20.

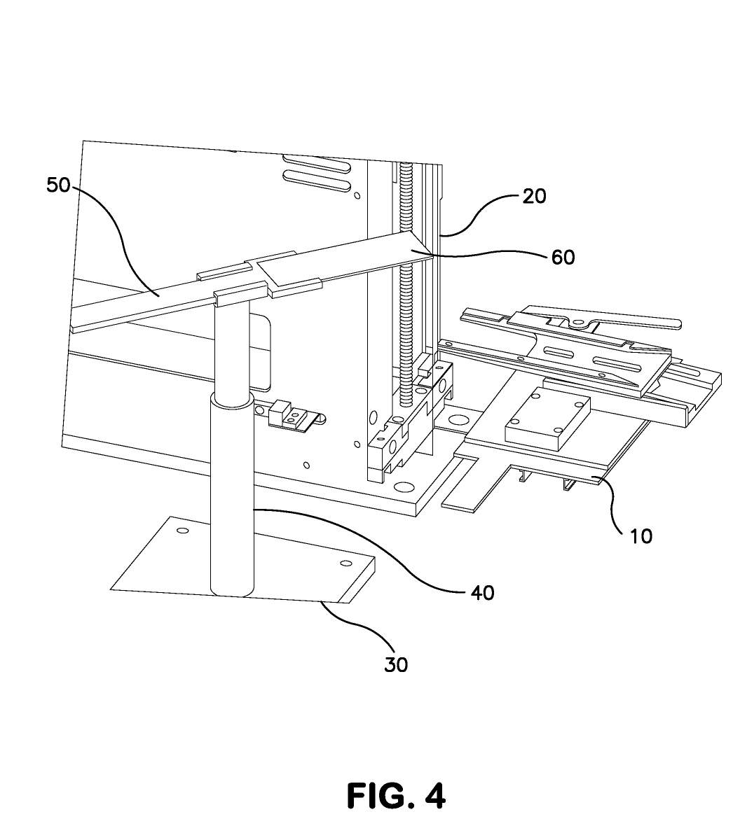

FIG. 4, a continuation of FIG. 3, depicts feed arm 50 rotated about the longitudinal axis of support column 40 toward slide stage 10.

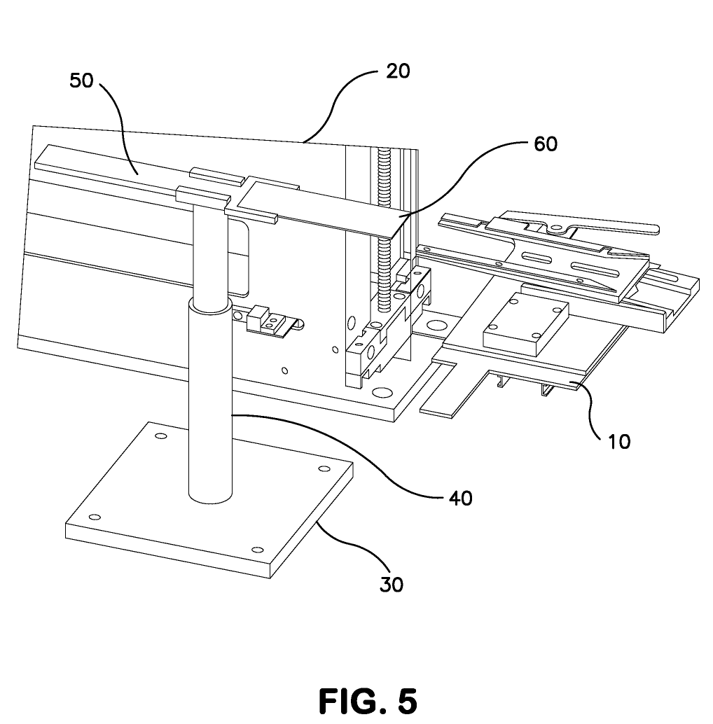

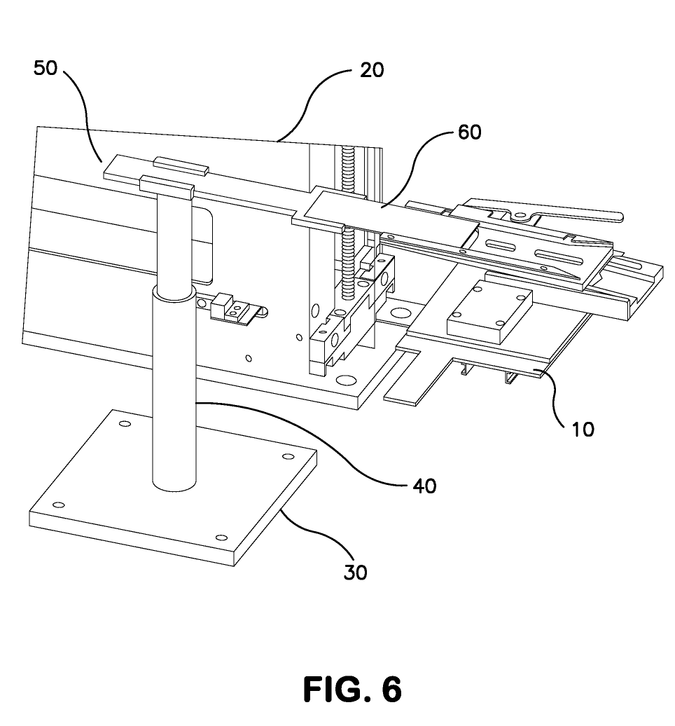

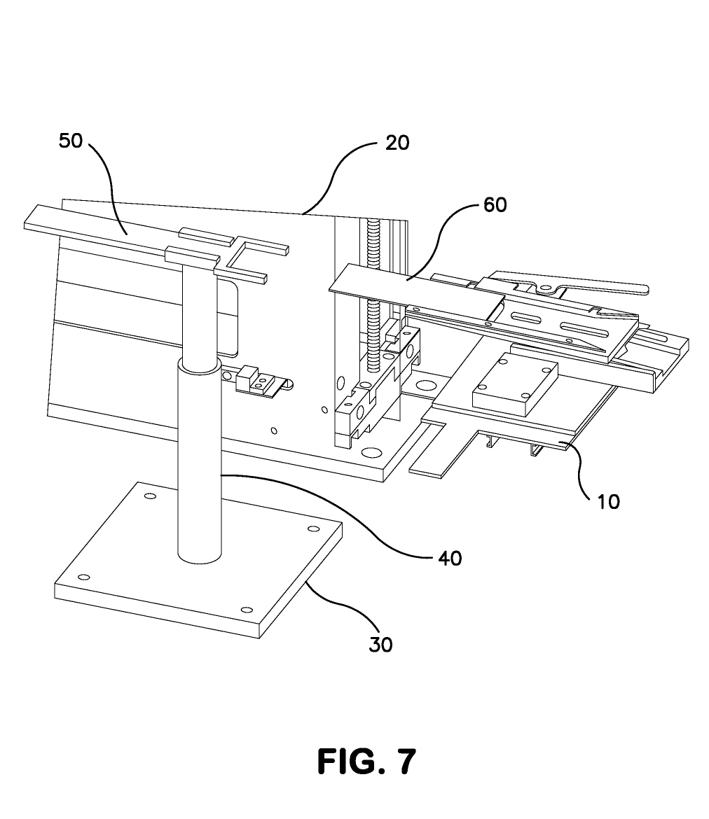

Turning to FIG. 5, feed arm 50, with microscope slide 60, is lined up with slide stage 10, ready to accept microscope slide 60. When feed arm 50 is once again extended, as depicted in FIG. 6, microscope slide 60 is positioned such that slide stage 10 can hold microscope slide 60. Once microscope slide 60 is held firmly by slide stage 10, feed arm 50 may retract, such as shown in FIG. 7.

### STATEMENT REGARDING PREFERRED EMBODIMENTS

While the invention has been described with respect to preferred embodiments, those skilled in the art will readily appreciate that various changes and/or modifications can be made to the invention without departing from the spirit or scope of the invention as defined by the appended claims. All documents cited herein are incorporated by reference herein where appropriate for teachings of additional or alternative details, features and/or technical background.

1. A microscope slide manipulation device, said device comprising:
a base structure;
a sleeve defining a through-void, said sleeve having a first end and a second end, said second end fastened to said base, and said sleeve being oriented perpendicular to said base;
a longitudinal shaft symmetric about an imaginary longitudinal axis in part positioned in said sleeve through-void in a manner to permit axial and longitudinal movement of said longitudinal shaft in said sleeve through-void, said longitudinal shaft having a shaft first end and a shaft second end, said shaft second end positioned within said sleeve through-void and said shaft first end projecting beyond said sleeve first end and including a parallel track structure in a plane perpendicular to said sleeve imaginary longitudinal axis;
a plate slideably positioned between said parallel track structures on said sleeve first end, said plate having a first plate end and a second plate end, one of said first plate end or second plate end having the form of a fork having at least two prongs, in a same plane, defining a void area between each prong that corresponds to the width of a microscope slide, and wherein said fork has a gripping structure operatively configured to permit gripping of a microscope slide along its edges.

2. A microscope slide manipulation device, in accordance with claim 1, further comprising said fork having an additional flat prong in another plane, parallel to said same plane.

3. A microscope slide manipulation device, in accordance with claim 1, further comprising:
a first linear actuator operatively associated with said sleeve or said longitudinal shaft which translates linear movement of said longitudinal shaft in said sleeve and;
a rotational actuator which translates rotational movement of said parallel track structure operatively associated with an element chosen from the group consisting of at least one said base structure, said parallel track structure, said plate and said longitudinal shaft.

4. A microscope slide manipulation device, in accordance with claim 4, further comprising at least one position determining sensor operationally configured to telemeter position information with respect to said two pronged fork with respect to a reference point.
